(19) United States
(12) Patent Application Publication
(10) Pub. No.: US 2007/0106510 A1
(43) Pub. Date: May 10, 2007

(54) Voice based data capturing system

(75) Inventors: Adrian S. Hsing, Foster City, CA (US); Shi Yan, Fremont, CA (US)

Correspondence Address: MORRISON & FOERSTER LLP, 755 PAGE MILL RD, PALO ALTO, CA, 94304-1018, US

(73) Assignee: IVRAS INC., San Mateo, CA (US)

(21) Appl. No.: 11/240,145

(22) Filed: Sep. 29, 2005

(51) Int. Cl. G10L 17/00; G06F 19/00

(52) U.S. Cl. 704/246; 705/3

(57) ABSTRACT

Methods and apparatuses for collecting data utilizing voice recognition and voice authentication technologies. In one variation, the method comprises recording a plurality of clinical data entries through voice inputs and verifying the identity of the user through voice authentication. The method can further include associating each of the recorded clinical data entries with the digital recording of a corresponding voice input. In another aspect, an apparatus is provided with voice authentication and voice recognition capabilities to record clinical data and verify user identity. In one variation, the apparatus is configured to assign an identity stamp and a time stamp to each of the clinical data entry stored in the database.

### FIELD OF THE INVENTION

The invention is related generally to the field of data capturing systems. In particular, the invention can be configured for recording and management of clinical data.

### BACKGROUND

Collection and management of clinical data can be a daunting task. In particular, typical procedures that are utilized in clinical data collection to ensure accuracy and provide proper attribution tend to be inefficient and difficult to manage. Many of the current processes that are utilized to ensure proper recordation and tracking of clinical trial data are cumbersome and require significant amount of financial resources to manage.

Furthermore, due to the regulatory requirements promulgated by the Food and Drug Administration (FDA), collection and management of clinical data during clinical trials have become especially tedious, difficult, and expensive. Specifically, 21 CFR part 11 mandates that source data collected during a clinical trial is to be maintained under the control of the investigator. FDA Guidance for Industry on electronic records and electronic signatures requires the organizations conducting clinical trials to ensure that clinical data collected during the trials to be Attributable, Legible, Contemporaneous, Original, and Accurate (ALCOA). To be attributable, the investigator should control the recorded clinical data, and provided an audit trail for any modification of the data. To be legible, the clinical data should be easily reviewed. To be contemporaneous, the clinical data should be entered at or around the same time as observation is made. To be original, the clinical data collected should be the version actually inputted by the investigator. To be accurate, the system/process collecting the data should minimize data entry error and maintain the integrity of the recorded data.

It can be difficult to build and maintain an electronic data collection system that meets all these requirements in a cost effective manner. In addition, many of today's clinical trials are performed in multiple locations. Thus, efficient and reliable transmission of data from the remote locations to a centralized data collection site can be an important requirement. However, many of the current data collection methods are outdated and inefficient. In particular, in addition to the already vast amount of paperwork resulting from recordation of the original clinical data, the tracking and management of the data further results in generation of substantial amounts of additional papers, which the system must also keep track of.

Thus, there is a need for an electronic clinical data collection system that can streamline clinical data collection process while at the same time support user authentication and maintain input data integrity. In particular, the ability to maintain original source input and provide reliable audit trail can be of significant advantage.

### SUMMARY OF THE INVENTION

Disclosed herein are methods and apparatuses for collecting data through voice inputs. In one variation, a voice entry is passed through a voice authentication process to verify the user's identity. The user then provides a data entry through a voice input. The voice input is passed through a voice recognition process and translated into a data entry (e.g., a selection between a plurality of choices, textual inputs, etc.) that is logged into the database. The corresponding voice input is recorded into a digital sound file. The digital sound file is then associated with the data entry in the database. Therefore, an auditor can later verify the accuracy of the data entry in the database by accessing the digital sound file, which is associated with the data entry. A digital ID tag, which is based on the voice authenticated user identification, may also be linked to the data entry. This process can be applied systematically for all data entries collected by the system, such that each of the data entries in the system can be accredited to a specific user, and an associated digital voice recording can be accessed to verify the data entry.

In another variation, voice recognition and voice authentication functionality are implemented to improve accuracy and reliability of the clinical data recording process. In one example, the voice authentication system is configured to support the ALCOA requirement set forth by the FDA. To ensure that the recorded clinical data is attributable, system controls and operating procedures can be implemented to ensure that the investigator has control of the recorded data, and user identities are verified before access to the system is granted. In addition, each data entry may be attributed to the specific user making the entry. For example, the identity of each of the user accessing the database is verified through a voice authentication system.

To ensure that the recorded clinical data is legible, the system can archive a certified copy of the original input source in a format that can be understood by human. For example, data entry can be provided through voice instructions (e.g., user vocally pronounces the specific words that represent clinical data or a choice from one or more selections of entries provided by the system), and each of the voice instructions are then stored in the database in a digital format.

To ensure that the clinical data is contemporaneously recorded, the system can be provided with an input mechanism that facilitates data entry during patient examination and/or laboratory results review. For example, the system can be configured to allow the medical practitioner to enter clinical observations/measurements through voice inputs while conducting clinical evaluation of the participating clinical trial subjects. Time stamps (i.e., electronic trails of time and/or date information) may also be provided for each data entry to allow subsequent evaluation of accuracy and completion.

To ensure that the recorded clinical data is original, technologies and processes can be implemented to guarantee that the original data source has not been manipulated and provide verifications that original source data are stored in the database. For example, the original voice instructions can be recorded in the database and associated with corresponding clinical data entries. User identification and time stamp may also be provided for each of the clinical data entries to allow subsequent audit of the authenticity for each of the data entries.

To ensure accuracy of the recorded clinical data, processes may be provided to minimize data entry error. In addition, audit trails may be provided to ensure that modifications of the data entries are properly accounted for. For example, editing/filtering (e.g., voice edit check) of the voice input provided by the user may be implemented to prevent collection of incoherent data and/or data that are out of a reasonable range. The system can also be configured to ensure each data entry is preserved in the system and can not be written over, and each modification is recorded as an additional entry with proper audit trial with identity stamps and/or time stamps.

One aspect of the invention includes methods for conducting a clinical trial. In one variation, the method comprises providing a computer server configured to receive electronic voice communications from a plurality of remotely located clinical research sites. A plurality of clinical data entries are then provided by medical practitioners with voice inputs through the electronic voice communications. The clinical data entries are then recorded in the computer server. Each of the recorded clinical data entries is then associated with a digital file of a corresponding voice input.

Another aspect of the invention includes a system for collecting clinical data through remote voice input while at the same time utilizing voice recognition and voice authentication processes to improve accuracy and reliability of the recorded data. In one variation the system comprises a computer configured to receive electronic voice communications from a plurality of remote locations. The computer is further configured to prompt a user to provide a clinical data of a patient through a voice input via one of the electronic voice communications. The voice input provided by the user is then digitally saved on the computer and then converted into a data entry and stored in a database. The data entry is then associated with the digitally saved voice input.

One of ordinary skill in the art having the benefit of this disclosure would appreciate that the clinical data recording system with voice authentication capability disclosed herein may provide one or more of the following advantages: streamline clinical trial processes, expedite access to source data, reduce monitor queries and onsite monitoring visits, expedite query turnaround, enhance data quality and legibility, improve data security and validity, and increase trial flexibility.

These and other embodiments, features and advantages of the present invention will become more apparent to those skilled in the art when taken with reference to the following more detailed description of the invention in conjunction with the accompanying drawings that are first briefly described.

### BRIEF DESCRIPTION OF THE DRAWINGS

FIG. 1 illustrates one example of a voice authentication system configured for recording clinical data.

FIG. 2 illustrates another variation of a voice authentication system.

FIG. 3 illustrates an exemplary method for conducting clinical data collection.

FIG. 4A illustrates an example for displaying clinical data on a computer monitor for user review.

FIG. 4B illustrates one example for displaying an audit trial of modifications made to a data entry.

FIG. 5 is a flow chart illustrating an example of a process flow implemented on one variation of a voice authentication system for recording clinical data.

FIG. 6 is a flow chart illustrating one variation of an user authentication process.

FIG. 7A is a flow chart illustrating one example for requesting numerical data inputs.

FIG. 7B is a flow chart illustrating another example for requesting clinical data inputs.

### DETAILED DESCRIPTION OF THE INVENTION

The following detailed description should be read with reference to the drawings, in which identical reference numbers refer to like elements throughout the different figures. The drawings, which are not necessarily to scale, depict selective embodiments and are not intended to limit the scope of the invention. The detailed description illustrates by way of example, not by way of limitation, the principles of the invention. This description will clearly enable one skilled in the art to make and use the invention, and describes several embodiments, adaptations, variations, alternatives and uses of the invention, including what is presently believed to be the best mode of carrying out the invention.

Clinical trial data collection is used herein as an example application of the voice authentication system, in order to illustrate the various aspects of the invention disclosed herein. Although the methods and systems disclosed herein can be particularly useful in clinical trial applications, in light of the disclosure herein, one of ordinary skill in the art would appreciate that variations of the methods and systems disclosed herein may also be implemented in various other data recordation and data management applications.

It must also be noted that, as used in this specification and the appended claims, the singular forms “a,” “an” and “the” include plural referents unless the context clearly dictates otherwise. Thus, for example, the term “a computer” is intended to mean a single computer or a combination of computers, “an electrical signal” is intended to mean one or more electrical signals, or a modulation thereof. Furthermore, the term “remote” as used herein means separated by an interval or space such that the two objects are not present in the same room. For example, a user remotely located from a server is stationed beyond the room that houses the server. In addition, medical practitioner as used herein includes, but not limited to, doctors, nurses, physician's assistants, individuals who assist doctors or nurses to enter clinical data into the clinical database, clinical research associates, other professionals who participate in clinical trials, and other professional who participates in clinical investigations or research.

In one example, the voice authentication system comprises a computer configured to receive electronic voice communications from a plurality of remote locations. The computer is further configured to prompt the user to provide the clinical data of a patient through voice inputs via one of the electronic voice communications channels. The voice inputs are digitally saved on the computer, and then converted into a data entry (e.g., textual representation) in the database. For example, a voice instruction stating “thirty-seven degrees Celsius” can be converted to an ASCII representation of “37° C.”. The ASCII representation of the temperature data is then stored as a separate entry/object in the database. The clinical data entry (e.g., the ASCII representation of the temperature) in the database is then associated with the digitally saved voice input.

In one variation, the computer system is configured with an electronic interface which connects the computer to a public telephone network. The computer system can also include an electronic interface which connects the computer to the Internet. In another variation, the computer system is further configured with a voice authentication capability to verify the identity of said user. In yet another variation, the computer system is configured with a voice edit check functionality to reject the clinical data when the clinical data entered by the user is outside of a predefined parameter. For example, the voice edit check may comprise of a voice recognition system that records the voice instruction, converts the voice instruction into a data entry in the database (e.g., text entry such as a numerical designation or range), and then compare the data entry with a predefined parameter (e.g., a pre-set numerical range) to verify that the data entry is within the predefined parameter. In another variation, when the entry is out of the predefined range, the system would request the user to re-enter the data. In yet another variation, when the entry is out of the predefined range, the system would ask the user to confirm that the entry is correct. If the user confirms that the out of range data entry is correct, the computer system would initiate a separate script/procedure (e.g., notify primary investigator and/or clinical research associate of a potential problem).

In another variation, the computer further comprises a voice recognition server having voice authentication capability, an instruction set server (e.g., primary web server, VXML server, etc.) which provides an executable script to the voice recognition server, and a data server which receives the clinical data from the voice recognition server and stores the clinical data. The computer can be configured to provide an identity stamp and a time stamp to each of the data entries provided by the user. The identity stamp and a time stamp can be associated with the data entry in the database and/or the digital voice recording of the voice instruction.

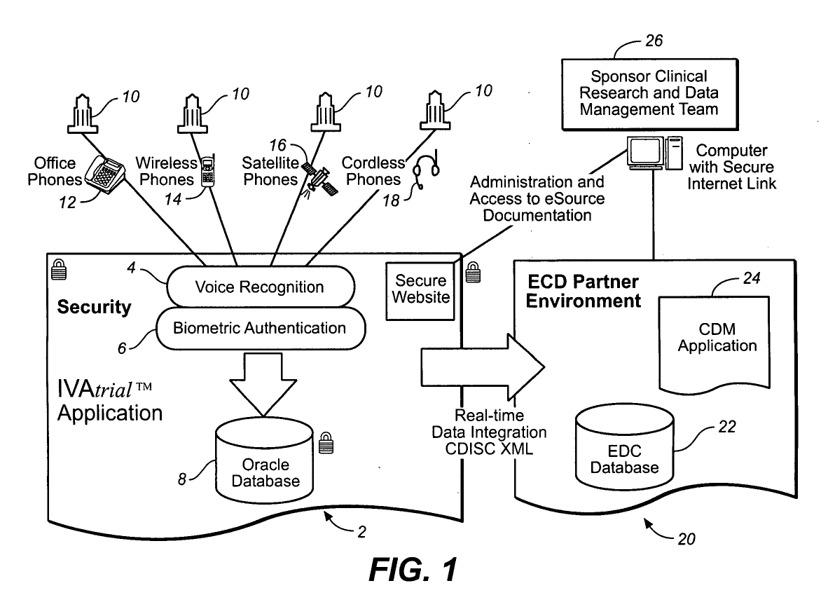

FIG. 1 illustrates another example of a voice authentication system 2 configured for recording clinical data. The system 2 comprises a voice recognition server 4 with biometric authentication functionality 6. A computer database 8 (e.g., Oracle® database) is connected to the voice authentication server 4 for receiving and storing clinical data. The system 2 further includes an electronic interface (e.g., a series of voice interface cards) that connects the system to a public service telephone network (PSTN). Multiple clinical research sites 10 can then access the system 2 through the public service telephone network. For example, one can access the system 2 through an office telephone 12 connected with a land-line connection, a wireless telephone 14 with wireless telephone network connection, a satellite phone 16 with satellite relay connection, or a cordless phone 18 in conjunction with a land-line connection.

In once variation, the system 2 also includes a broadband connection that allows data transfer through the Internet. A web server is provided to support accessing of the data through the Internet, such that professionals working on the clinical trial can access the clinical data stored on the database through computers or workstations that are remotely located from the system. In one configuration, multiple computers located in different cities can access the database simultaneously through web interfaces (e.g., Internet Explorer). For example, the primary investigator can access the system to perform database administration duties and access eSource data and documents (i.e., electronic source data and documents that are captured electronically without an original paper record) remotely.

Customers (e.g., clinical trial partners, pharmaceutical companies, clinical research organizations, etc.) can configure their Electronic Data Capture (EDC) systems to remotely access and/or download data from the system database 8 through a network connection (e.g., a secured Internet connection). In one variation, Internet connection can be established between the system and the customer's EDC partner environment 20. Data is then transferred utilizing CDISC (Clinical Data Interchange Standards Consortium) XML format. The clinical data can be downloaded from the system database 8 onto the EDC database 22 for processing and archiving. The EDC partner environment 20 may also include clinical data management (CDM) applications 24 that can be utilized for data processing and analysis of the clinical data stored in the EDC database 22. The sponsor clinical research and data management team 26 can also access the EDC system to process and/or manage the clinical data. In one variation, the system database 8 is configured for short term storage of recorded clinical data. In this variation, clinical data on the system database 8 is regularly downloaded onto the EDC database 22, such that the customer maintains control of all the clinical data that are collected by the system.

In one application, the medical practitioner calls into the system via a telephony device. The call can be established through a wireless phone, an office telephone, or any other kind of devices that can establish a direct voice-line into the voice recognition server. As discussed earlier, the voice recognition server can be configured with both voice recognition and biometric authentication functionalities, such that when the investigator vocally pronounces an instruction, the voice instruction is parsed out into specific data.

For example, the medical practitioner says “temperature ninety-nine”, the system would digitize the voice instruction and parse out the voice instruction through the voice recognition engine and enter a data entry in the database to represent that the temperature is “99”. In one variation, the medical practitioner's voice is authenticated when he logs onto the system. For example, the system can request the medical practitioner to provide a voice entry in the form of a phrase or a series of numbers. The voice entry is then compared with a prerecorded voice print to verify the identity of the medical practitioner. This authentication process prevents the sharing of user ID and passwords, and allows the system to verify the identity of the individuals accessing the system with confidence.

The data entry that is parsed out of that voice recognition process is then directed into the system database. The system may include separate redundant database such that each data entry into the system database is replicated in the redundant database to ensure data security and integrity. The redundant database may be configured locally or remotely at a separate location. The data in the system database can be further integrated into yet another database, which can be owned and/or operated by a partner or a customer. As discussed above, the system database can be configured either to serve as the primary data storage site or as a temporary data storage location. In one variation the system is configured such that the user has direct access to the clinical data entries as well as the source documents (e.g., digital voice recording) for verification of the data entry. The customer/partner can download both the clinical data entries and the source documents onto their system. Optionally, the customer/partner may choose to download only the clinical data entries that are recorded on the system database.

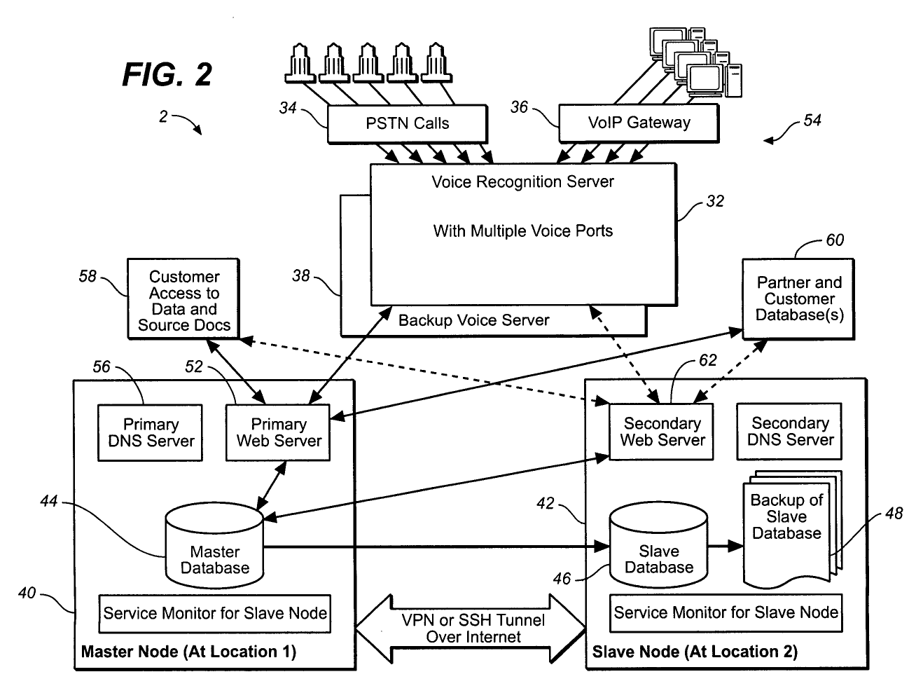

Referring to FIG. 2, another variation of a voice authentication system 2 is illustrated in detail. In this variation, the voice recognition server 32 is configured with a number of voice interface cards for receiving voice communications. The voice recognition server is further integrated with voice authentication capability. The voice interface cards are connected to the PSTN 34 to receive incoming telephone calls. The voice recognition server can be further configured with a VOIP gateway 36 to receive communications coming from voice over IP phones.

As shown in FIG. 2, the system is set-up with redundancies so that if part of the system fails, the system can continue to support its regular functionalities. For example, a backup voice recognition server 38 is provided such that in the event that the primary voice recognition server 32 has failed, the backup voice recognition server 38 will receive and process the incoming calls. The primary data storage site (i.e., Master Node 40), which may be remotely located in relation to the voice recognition server 32, is also replicated in a corresponding system (i.e., Slave Node 42, which is the mirror image of the Master Node 40). Once the data entry is saved onto the master database 44, the slave database 46 may be immediately updated. In addition, in the event that the Master Node 40 has failed, the voice recognition server 32 can utilize the Slave Node 42 as the primary server to store and process clinical data. In one variation, the Slave Node 42 is remotely located in relation to both the Master Node 40 and the Voice Recognition servers 32, 38. For example, the voice recognition servers 32, 38, the Master Node 40, and the Slave Node 42, can each be located in a different city. Furthermore, the slave database 46 can be further backed-up by duplicating the data on a long-term data storage medium 48 on a regular basis, to provide an optional disaster recovery mechanism. For example, every 24 hours the data in the slave database 46 can be backed-up with a tap drive.

In this example, the Master Node 40 further comprises a primary web server 52. The primary web server 52 provides instructions to the voice recognition server 32 and manages user access. In one variation, the primary web server 52 and the master database 44 are implemented on a single device. The primary web server 52 stores and manages the codes from which the voice recognition server 32 functions (i.e., the primary web server 52 commands the voice recognition server 32). Voice instructions from the user are received and processed by the voice recognition server 32 according to instruction provided by the primary web server 52. The resulting data entry is then transmitted to the primary web server 52 and then further directed to the database 44 by the primary web server for storage. In another variation, the primary web server 52 and the codes that are utilized by the primary web server to control the voice recognition server are placed directly on the computer supporting the voice recognition server 32.

The system configuration shown in FIG. 2, where the primary web server 52 is separated from the voice recognition server 32, can be utilized to allow one to leverage a single voice recognition infrastructure 54 to serve multiple customers. For example each customer (e.g., pharma, CRO, etc.) is provided with a separated primary web server with a dedicated database. However, all the primary web servers are connected to a single voice recognition infrastructure 54 (which may include one or more voice recognition servers) so that as the overall system is scaled-up to support more customers, there is no need to expand the voice recognition infrastructure at the same rate. For example, the system can be configured such that there is no need to dedicate five voice ports each of the customers; instead, a hundred voice ports can be utilized to serve a large number of customers. This configuration may provide improved balance on system load and facilitate overall system operation efficiency.

In addition, a DNS server 56 is provided to direct internet traffic and allow user to access the web server through Internet connections. For example, the DNS server 56 can be configured to direct traffic going to URL www.ivatrial.com to the appropriate web server. The link between the primary web server 52 and the DNS server 56 is conducted over secure internet protocol (e.g., https). The DNS server 56 can be located at the same location as the primary web server 52. In another variation, the DNS server 56 is located remotely from the primary web server 52.

The codes/instructions for specific clinical trials are stored on the primary web server 52. When a medical practitioner calls in and connects with the voice recognition server 32, the voice recognition server 32 will request instructions from the primary web server 52. The primary web server 52 then instructs the voice recognition server 32 to interact with the medical practitioner to collect the clinical information from the medical practitioner. For example, the primary web server 52 can instruct the voice recognition server 32 to provide specific voice prompts to solicit specific information from the medical practitioner.

In one example, the voice recognition engine on the voice recognition server 32 comprises a commercially available voice recognition engine, NUANCE®, and VXML codes are implemented on the primary web server 52 to control the NUANCE® voice recognition engine. There can be continuous exchange of data between the voice recognition server 32 and the primary web server 52 that executes the VXML codes. The operations of the voice recognition server 32 and the primary web server 52 are interrelated during each clinical data recording session initiated by a medical practitioner who calls into the system. The voice recognition engine software can be pre-configured with a set of action specific scripts or functions. The primary web server 52 then provides specific VXML codes that instruct the voice recognition server to execute specific instruction sets.

By housing the VXML code on the primary web server 52, one can easily replicate the VXML code and modify the VXML code with specific instructions to meet different clinical trial needs. This configuration further provides scalability to the overall system to support multiple clinical trials and multiple customers. The primary web server can be replicated and then customized with trial specific VXML codes.

In addition, the primary web server 52 is further configured with an Internet gateway to support customer access 58 to the source documents/data stored on the master database. The primary web server is further configured to permit partners and customers databases 60 to access the master database 44 and download clinical data stored on the master database 44. As discussed earlier, since the Slave Node 42 is a mirror image of the Master Node 40, when the primary web server 52 is inoperable, customer access to the database, and partner/customer database queries can be directed towards the secondary web server 62.

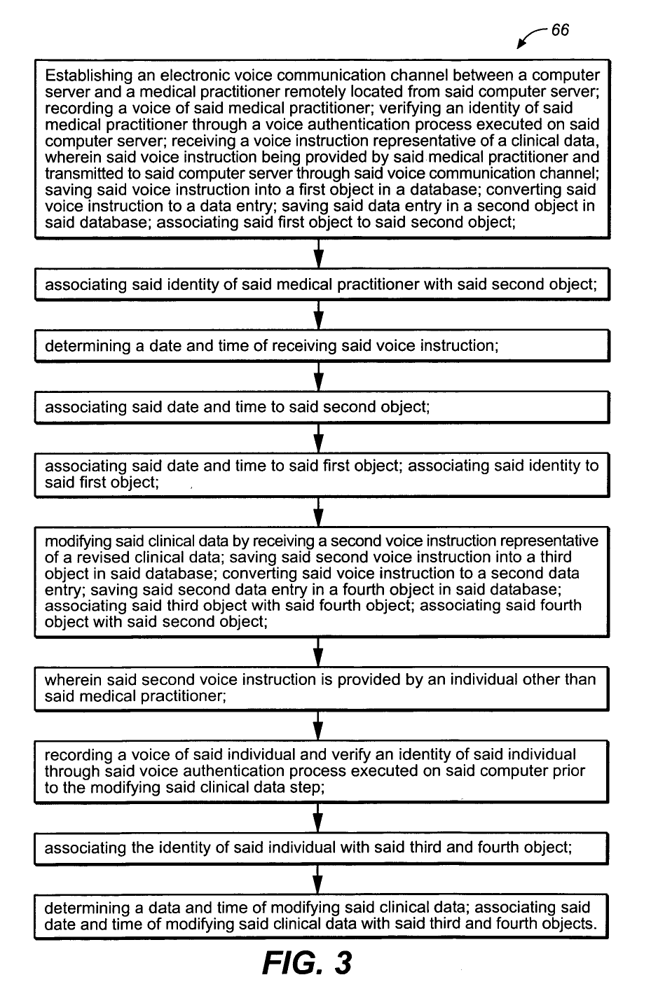

In another aspect, methods for conducting clinical data collection through voice recognition system are disclosed herein. An exemplary method 66 is illustrated in FIG. 3. “Association” as used herein means interrelating one or more clinical data entry with other objects or files stored in the database. For example, as one of ordinary skill in the art would appreciate, one or more objects in a database can be interlinked with each other. In another variation, various objects can be associated with each other by storing them in a given file of a database. Individual files can also be associated with each other through pointers or other reference mechanisms that are well known to one of ordinary skill in the art. In another variation, objects and/or data entries are associated by displaying them side by side on a computer monitor.

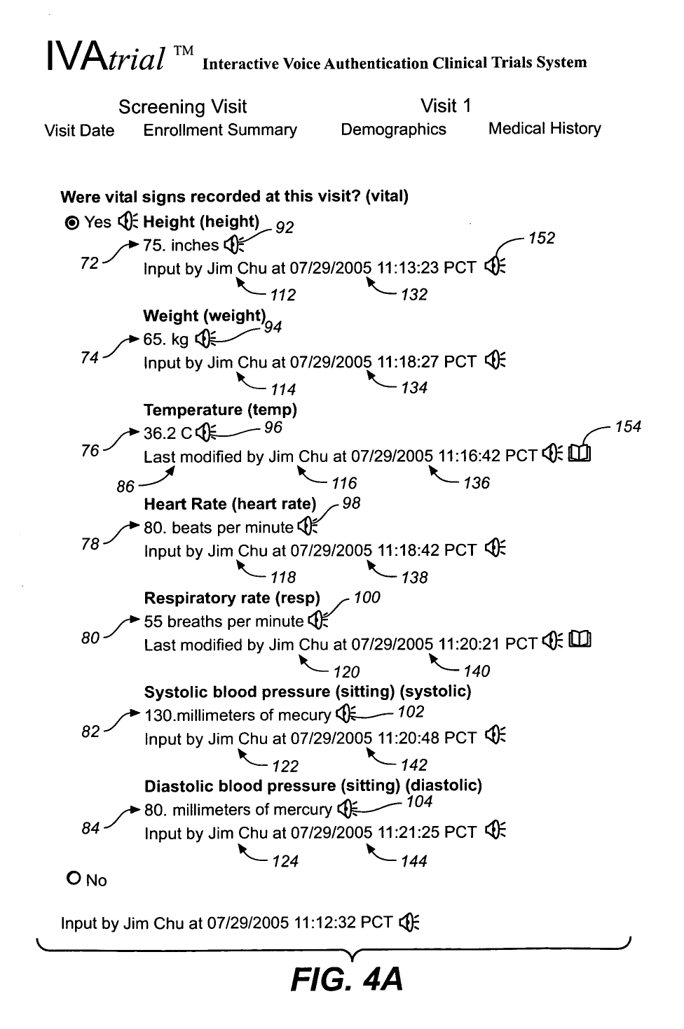

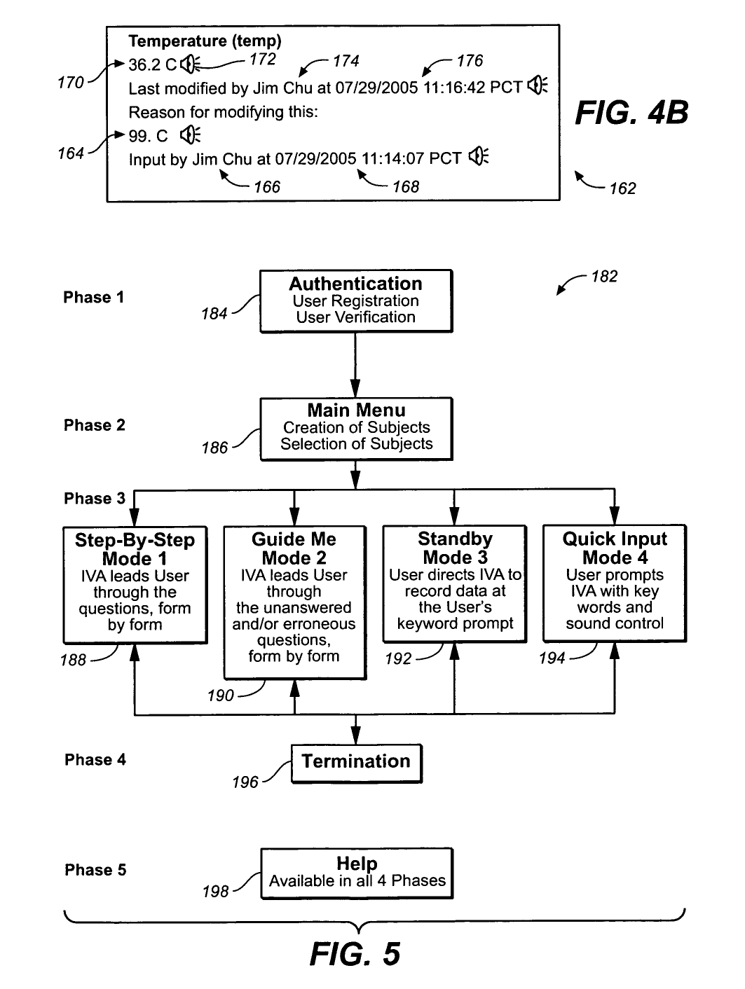

Once the recorded data entry and associated digital voice recording of the voice instruction are saved in the database, they can be retrieved from the database and displayed on a computer screen. In one variation, each data entry 72, 74, 76, 78, 80, 82, 84 is displayed along with its corresponding digital voice recording 92, 94, 96, 98, 100, 102, 104 of the voice instruction, as shown in FIG. 4A. In addition, the identity of the medical practitioner 112, 114, 116, 118, 120, 122, 124 who provided the voice entry, and a time stamp 132, 134, 136, 138, 140, 142, 144 indicating the date and time of the entry, can also be displayed along with the data entry 72, 74, 76, 78, 80, 82, 84. In the example shown in FIG. 4A, the user enters height information with a voice instruction stating “seventy-five” The voice instruction is digitized and then analyzed by the voice recognition engine in the voice recognition server and converted into a data entry “75”, and then displayed as “75. inches”. The digitized voice instruction is saved as an objection in the database, and displayed as a “speaker symbol” 92 next to the data entry “75. inches” 72. The identity of the user 112 along with the data entry time stamp 132 is displayed just below the data entry “75. inches” 72.

Optionally, the system may request the medical practitioner to review the voice entry by playing back the recorded voice instruction, and asking the medical practitioner to confirm that the entry is correct by stating “confirmed.” In this variation, when the medical practitioner confirms the entry, the identity stamp 112 and time stamp 132 are logged into the database and associated with the data entry 72. Furthermore, the medical practitioner's voice input, “confirmed”, is also saved into the database as an object and associated with the data entry. A second “speaker symbol” 152, which is linked to the digital voice recording “confirmed”, is displayed next to the time stamp 132. Other data entries for weight 74, temperature 76, heart rate 78, and so forth are also shown in FIG. 4A.

Within FIG. 4A, the “Temperature” entry 76 illustrates an example where the data has been modified. As displayed, “36.2 C” 76 indicates that the latest (i.e., post-modification) temperature is 36.2 degree Celsius. The sentence below the “36.2 C” data entry states “Last modified . . . ” 86 indicating that the data entry 76 has been modified. Identity stamp 116 and time stamp 136 of the modification are also provided. A “book symbol” 154 is provided after the time stamp to allow the user to access the “audit trail” of the modification. To review the history of the modification, the user simply clicks on the “book symbol” 154 and a window 162 will pop-up with the history of the data modification for the “Temperature” entry 76, as shown in FIG. 4B. When the original entry of “ninety-nine” was provided, the system recognized that “99” was out of range and prompted the user to revise the data entry. However, as shown in FIG. 4B, the original input is not simply overwritten by the new input, but instead, is kept in the database. The original input is displayed as “99. C” 164 and the corresponding identity stamp 166 for the individual who entered the data, and the associated time stamp 168 is provided just below the entry. The new entry “thirty-six point two” is displayed as “36.2 C” 170 along with its corresponding digital recording 172 of the voice instruction. The identity stamp 174 of the person making the modification and the associated time stamp 176 is provided just below the “36.2 C” entry 170.

In one variation, modification of the data entry may be provided without a specific prompt by the system. Two or more modifications can be provided if necessary and each of the modification will be recorded and saved in the database, such that the complete modification history can be displayed to the user when requested.

In another variation, the method for managing clinical data comprises providing a computer server configured to receive electronic voice communications (e.g., telephone line, cell phone connection, Voice Over IP, Public Service Telephone Network, satellite phone connection, and various electronic channels for transferring sound, etc.) from a plurality of remotely located clinical research sites. A plurality of clinical data entries are then recorded on the computer server. The clinical data entries can be provided by medical practitioners, with voice inputs through the electronic voice communications. The voice inputs are digitally saved on the computer and converted to clinical data entries that are recorded in the database. Each of the recorded clinical data entries is then associated with a digital file of a corresponding voice input.

Clinical data entry can include information from one or more of the following sources: medical history information (e.g., whether the subject's father had cancer or stroke, etc.), medical examination results (e.g., subject's temperature, heart rate, etc.), lab results (e.g., blood test data, etc.), demographic data (e.g., subject's age, sex, height, weight, etc.), administrative information (e.g., subject's ID number, whether informed consent has been executed, etc.), treatment information (e.g., dosage, delivery time, etc.), information regarding concomitant medications (e.g., name and dosage of the drug, etc.), information regarding treatment complications, and information regarding intercurrent illness. One of ordinary skill in the art having the benefit of this disclosure would appreciate that clinical data entry is not limited to the ones described above, and can include any information that may be useful in a clinical trial or medical treatment setting.

The method can further comprise updating a central database after each of the plurality of clinical data entry has been recorded. The clinical data entries can then be displayed on a computer monitor. In one variation, once the data is entered through the voice communication channel from a remote location into a database in a central server, the updated information can be transmitted through the Internet and displayed in real-time (i.e., data update is processed by the central server immediately, and preferably the remotely located computer can receive the updated information from the central server within one minute; more preferably, the remotely located computer can receive the updated information from the central server within seconds of initial input, such as less than ten seconds or less) on a computer monitor located at the remote location. In addition, the user may chose to playback the digital file of the corresponding voice input that was recorded earlier. For example, an icon representing the digital voice file may be associated with a clinical data entry (e.g., 37° C.) by placing the icon next to the text display (e.g., “37° C.”). When the user selects the icon, the voice file/object of the medical practitioner stating “thirty-seven degree Celsius” can be played back by the remotely located computer.

Furthermore, the method may further include the process of performing edit checks on at least one of the plurality of clinical data entries. For example, once the voice instruction is recorded by the computer server and entered into the database as an entry in the database, an executing computer program will check to see if the data entry is within a predefined range. If the data entry is outside of the predefined range, the computer server can reject the data entry and then request the user to provide a revised entry. In another variation, the computer server is configured to advise the user that the entry is out of the range, and prompt the user to confirm the entry or provide a corrected the entry. The method may also include the process of verifying the identities of each of the medical practitioner through analyzing a voice recording of each of the medical practitioner accessing the system. For example a program utilizing biometric analysis can be implemented to compare the recorded voice with a previously recorded voice print of the individual medical practitioner to verify the identity of the medical practitioner.

Once the clinical data has been recorded in the database, an individual with proper authority may later access the database to review one or more of the previously entered clinical data. In one variation, the server is configured such that individual users are assigned various levels of access restrictions depending on each individual's particular role in the clinical trial, and only individuals with high level access authority are permitted to modify the clinical data entry. In one configuration, the revised clinical data entries are provided in the form of additional voice inputs. The voice instructions of the revised clinical data entries are recorded and stored in the database as objects/files. The voice instructions are then converted into specific data entries on the database. The objects representing the digital recording of the voice instruction are then associated to the specific data entries representing the revised clinical data entry.

FIG. 5 is a flow chart illustrating an example of the process flow 182 implemented on a voice authentication system to record clinical information from a user who accesses the system to submit clinical data. In this particular design, the user interface protocol is divided into five phases. In Phase 1, when the user has just established voice communication with the system, the system prompts the user for registration information, such as an ID number or a telephone number 184. The system then records a voice entry from the user, such as the user's voice instruction that provides the ID number and utilizes it to verify the user's identity. The system then confirms the user's identity through voice authentication. For example, the recorded voice entry is compared with a voice print that was previously saved in the system.

Once the identity of the user has been verified, the user is directed to a main menu 186 where the user can create a new clinical trial subject, or select an existing clinical trial subject in order to enter corresponding clinical data for that particular subject. In Phase 3, the user is provided with four different options to enter the data. In Mode 1, the system provides voice prompts and guides the user through all the questions for each subject 188. In Mode 2, the system provides voice prompt and requests the user to provide information for only those questions that are unanswered and/or has erroneous entries 190. In Mode 3, the system is put in a stand-by mode and ready to receive user's entry at user's own pace 192. The user directs the system by providing keywords and corresponding clinical data. Mode 3 utilizes a vocal phrase to “wake up” the system from Standby. Mode 4 is configured for use with a mute button that is toggled on when inputting data and off when not inputting data. Once the data entry process has been completed, the user is directed to Phase 4, which allows the user to logout of the system 196. An optional Phase 5 is accessible from any of the previous four phases to provide user with an interactive help menu 198.

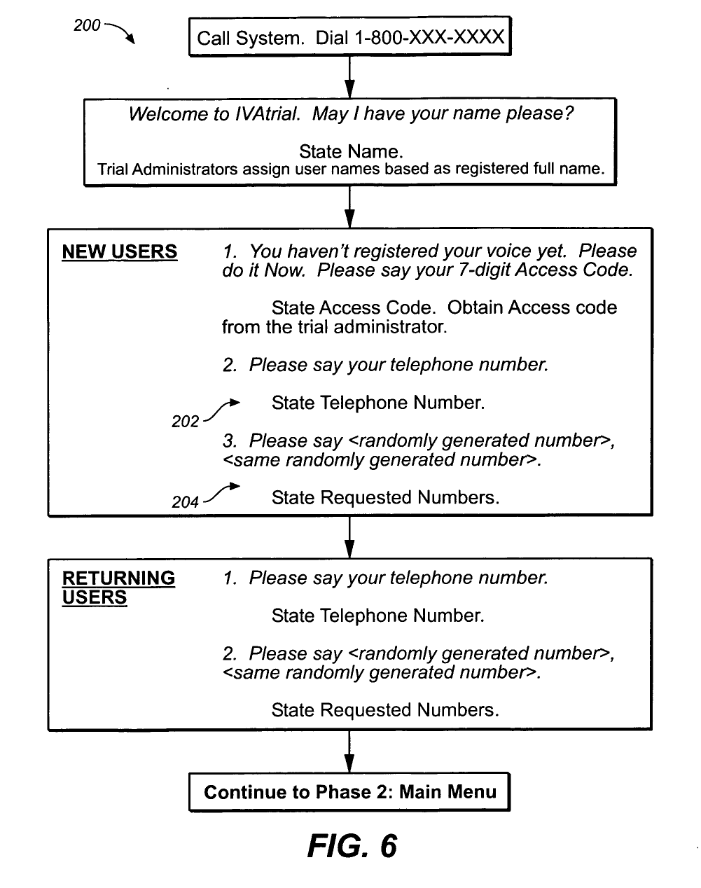

FIG. 6 illustrates a flow chart of one variation of an authentication process 200. In this example the user is requested to provide a telephone number (i.e., “State Telephone Number” 202) and to say a randomly generated number provided by the computer (i.e., “State Requested Number” 204). The telephone number can be used to determine the specific user that is trying to obtain access to the system, and the digital recording of the user stating the randomly generated number can then be used to verify whether the user is actually who he has identified himself to be (i.e., the person associated with the given telephone number). By utilizing a randomly generated number for voice authentication, the system can prevent an unauthorized user from gaining unauthorized access by recording the voice of an individual with authority to enter the database. In another variation, the system simply utilizes the voice entry which states the user's telephone number to match-up with an existing voice print to verify the user's identity.

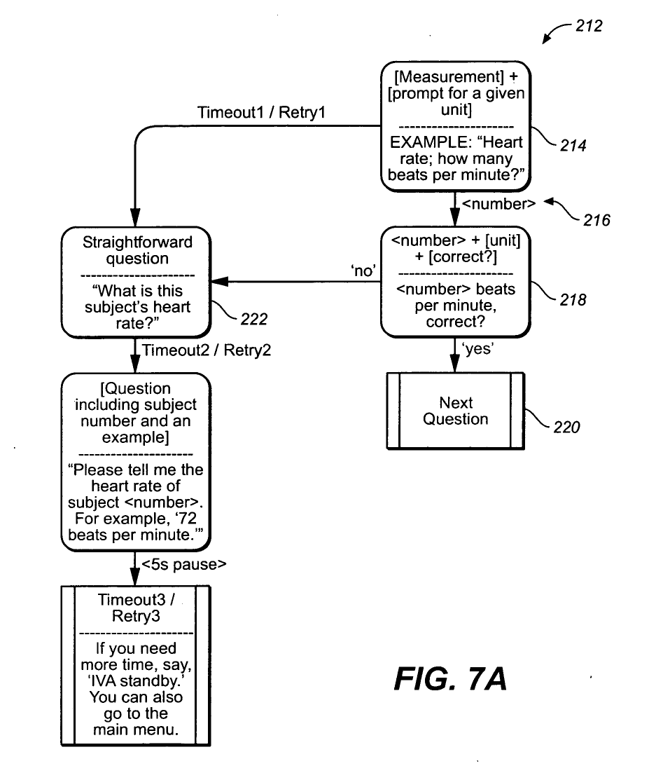

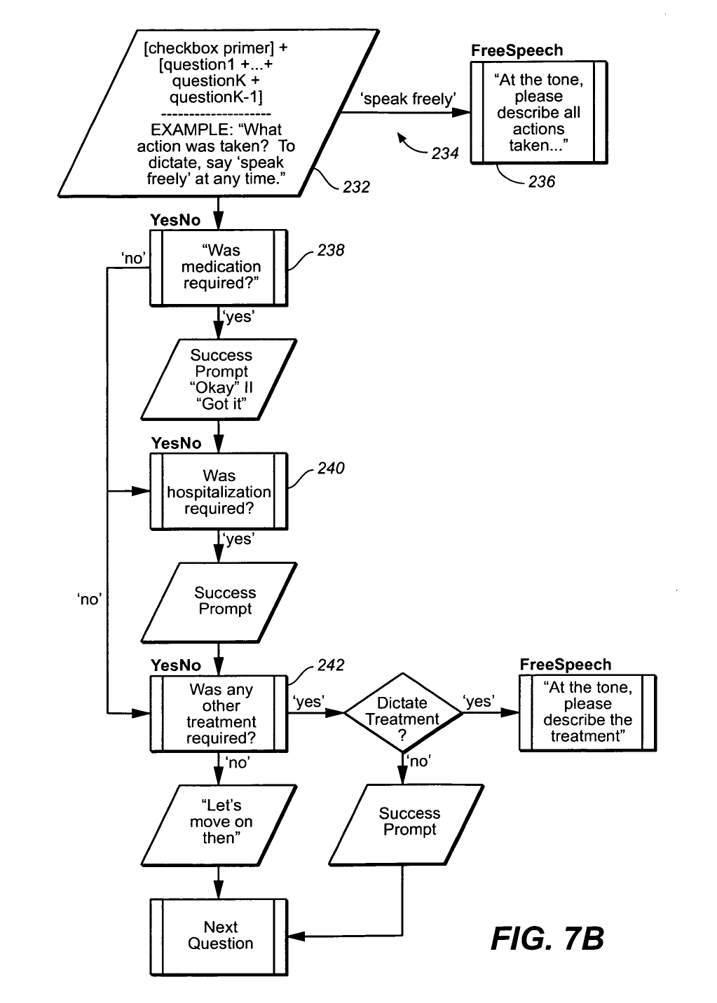

As discussed above, in one variation, the system is configured to prompt the user to provide clinical data. FIG. 7A is a flow chart illustrating one example for requesting numerical data 212. In this example, the system prompts the user to provide heart rate information by stating “Heart rate. How many beats per minute?” 214. The system then records the user's voice input 216 and utilizes the voice recognition engine to convert the voice input into a data entry. The system then verifies whether the recorded data entry for the heart rate is within a predefined range pre-programmed into the system 218. If the data entry for the heart rate is within the predefined range, the system then moves onto a new question 220. If not, the system then prompts the user to re-enter the hear rate 222.

The system can also prompt the user to provide an extensive verbal description of a particular clinical condition or situation. For example, as shown in FIG. 7B, the system prompts the user to provide a description of the actions that was taken 232. The user can then request to speak freely without the constraint of a particular input format 234. The system then confirms the execution of free speech mode and requests the user to dictate all the actions taken. The complete verbal input provided by the user is saved into the database as a single object or file. In this example, once the user provides the extensive description, a serious of related yes or no questions 238, 240, 242 are then directed towards the user. Each of the yes or no answers is then recorded in the database and associated with its corresponding question.

One of ordinary skill in the art having the benefit of this disclosure would appreciate the voice based data capturing system described herein can be utilized in various other industry, and it is not limited to the medical industry. In one variation, the voice based data capturing system is utilized to record financial transactions initiated by a customer of a financial institution. For example, the customer calls into the data center and uses his voice to instruct the system to transfer $200 from his savings account to his checking account. The system first prompts the customer to identify him self by stating his name, account number or social security number. The system then records the voice entry, and through voice recognition verifies the identity of the customer. Through a series questions and corresponding voice entry answers, the user navigates through a decision tree to a point that allows the user to transfer money between the saving account and the checking account. The system then prompts the customer to provide the amount of money to be transferred. The customer provides a voice entry stating “two hundred dollars.” The system utilize voice recondition to record the transfer of $200 in the data base, at the same time records the voice entry “two hundred dollars” in a digital file. The voice entry digital file is then associated with the $200 transfer in the database. In addition, the customer's identity, which was verified through voice recognition, may also be associated with the $200 transfer recorded in the data base (e.g., through a digital identity tag). Later in time, when a manager from the financial institution is auditing the money transfer, he will be able to verify the instruction provided by the user by accessing the digital file of the voice recording. In addition, the manger may also verify the identity of the individual who authorized the transfer of money accessing the identity tag.

In another application, a similar system may be utilized for a user to debit his checking account or charge his credit card, by allowing the system to verify the user's identity through voice recognition, and then records his voice instructing the system to debit or charge a certain amounts of money, such that the transaction is documented in the data base as an data entry and an associated voice file and/or the identity of the user. In this application, every transaction can be recorded as a data entry in the data base along with the voice instruction and ID tag, such that each and every one of the transactions can be audited later.

In another variation, the system can be applied to an operation where voice communications/instructions needs to be recorded to provide accountability in the future. In one variation, communications between the airplane pilot and the control tower are recorded by the voice data capturing system. For example, as an airplane approaches the control tower the system prompts the pilot to identify himself and his airplane. The pilot's identity is verified through the voice authentication system, and information provided by the pilot are transferred into textual data through voice recognition and recorded in the database. The database entry is associated with the digital voice recording of the instructions or voice entries provided by the pilot. In addition, communications between the pilot and the control tower can also be recorded in a digital file, and then linked to the voice authenticated identity tag. Therefore, in the future, an auditor can track the communication of a particular event by retrieving the data and the associated digital voice recordings and the identity tags.

This invention has been described and specific examples of the invention have been portrayed. While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well. Finally, all publications and patent applications cited in this specification are herein incorporated by reference in their entirety as if each individual publication or patent application were specifically and individually put forth herein.

What is claimed as new and desired to be protected by Letters Patent of the United States is:

1. A method of clinical data capture comprising:
establishing an electronic voice communication channel between a computer server and a medical practitioner remotely located from said computer server;
recording a voice of said medical practitioner;
verifying an identity of said medical practitioner through a voice authentication process executed on said computer server;
receiving a voice instruction representative of a clinical data, wherein said voice instruction being provided by said medical practitioner and transmitted to said computer server through said voice communication channel;
saving said voice instruction into a first object in a database;
converting said voice instruction to a data entry;
saving said data entry in a second object in said database; and
associating said first object to said second object.

2. The method according to claim 1, further comprising:
comparing said clinical data with a predefined parameter.

3. The method according to claim 2, further comprising:
rejecting said voice instruction when said clinical data is outside a range defined by said predefined parameter; and
requesting said medical practitioner to provide a replacement voice instruction when said voice instruction is rejected.

4. The method according to claim 1, further comprising:
associating said identity of said medical practitioner with said second object.

5. The method according to claim 4, further comprising:
determining a date and time of receiving said voice instruction.

6. The method according to claim 5, further comprising:
associating said date and time to said second object.

7. The method according to claim 6, further comprising:
associating said date and time to said first object; and
associating said identity to said first object.

8. The method according to claim 7, further comprising:
displaying said data entry on a computer screen located remotely from said computer server; and
displaying an icon representing said first object next to said data entry on said computer screen.

9. The method according to claim 8 wherein the displaying said data entry on a computer screen step is performed in real-time in relation to said receiving a voice instruction representative of a clinical data step.

10. The method according to claim 7, further comprising:
modifying said clinical data by receiving a second voice instruction representative of a revised clinical data;
saving said second voice instruction into a third object in said database;
converting said voice instruction to a second data entry;
saving said second data entry in a fourth object in said database;
associating said third object with said fourth object; and
associating said fourth object with said second object.

11. The method according to claim 10, further comprising:
determining a date and time of modifying said clinical data.

12. The method according to claim 11, further comprising:
associating said date and time of modifying said clinical data with said third and fourth objects.

13. The method according to claim 10, wherein said second voice instruction is provided by an individual other than said medical practitioner.

14. The method according to claim 13, further comprising:
recording a voice of said individual and verify an identity of said individual through said voice authentication process executed on said computer prior to the modifying said clinical data step.

15. The method according to claim 14, further comprising:
associating the identity of said individual with said third and fourth object.

16. The method according to claim 15, further comprising:
determining a data and time of modifying said clinical data; and
associating said date and time of modifying said clinical data with said third and fourth objects.

17. The method according to claim 1, wherein said verifying said identity of said medical practitioner step is performed via a biometric biometric-based personal verification program.

18. The method according to claim 1, wherein the verifying an identity of said medical practitioner step comprises comparing said recorded voice of said medical practitioner with a previously recorded voice of said medical practitioner through a biometric algorithm.

19. The method according to claim 1, wherein said electronic voice communication channel comprises a connection selected from a group consisting of telephone connection, a cellular telephone connection, a voice over IP connection, and a satellite telephone connection.

20. The method according to claim 1, wherein said computer server is located at least 10 miles away from said medical practitioner.

21. The method according to claim 1, further comprising:
establishing a plurality of electronic voice communication channels between said computer server and a plurality of medical practitioners, wherein each of said plurality of medical practitioners is located at a different location.

22. The method according to claim 21, further comprising:
verifying identities of said plurality of medical practitioner; and
receiving a plurality of voice instructions from said plurality of medical practitioner.

23. The method according to claim 22, further comprising:
saving said plurality of voice instructions on said computer server;
converting said plurality of voice instructions into a plurality of text entries; and
associating each of said plurality of text entries with a corresponding voice instruction.

24. The method according to claim 23, further comprising:
associating each of said plurality of text entries with a corresponding medical practitioner's identity.

25. The method according to claim 1, wherein the converting said voice instruction to a data entry step comprises utilizing a voice recognition program operating on said computer server to convert said voice instruction to said data entry.

26. The method according to claim 1, further comprising:
displaying a plurality of text entries representing a plurality of clinical data on a computer screen, wherein each of said plurality of text entries being displayed along with an icon representing a digital voice recording of a corresponding voice instruction.

27. The method according to claim 26, further comprising:
selecting one of said icons to retrieve and playback said corresponding voice instruction.

28. The method according to claim 26, wherein each of said plurality of text entries being displayed along with a corresponding identity of an individual who provided said clinical data.

29. A method of conducting a clinical trial comprising:
providing a computer server configured to receive electronic voice communications from a plurality of remotely located clinical research sites; and
recording a plurality of clinical data entries in said computer server, said clinical data entries are provided by medical practitioners with voice inputs through said electronic voice communications, wherein each of said recorded clinical data entries is associated with a digital file of a corresponding voice input.

30. The method according to claim 29 further comprising:
updating a central database after each of said plurality of clinical data entry has been recorded.

31. The method according to claim 30 further comprising:
displaying one of said plurality of clinical data entry on a computer monitor;
playing back said digital file of said corresponding voice input.

32. The method according to claim 29 further comprising:
providing real-time display of said plurality of clinical data entries on a computer monitor as each of said plurality of clinical data entry is recorded.

33. The method according to claim 29 further comprising:
performing edit check on at least one of said plurality of clinical data entry.

34. The method according to claim 33 further comprising:
rejecting said at least one of said plurality of clinical data entry when said at least one of said plurality of clinical data entry is outside of a predefined range.

35. The method according to claim 34, further comprising:
verifying an identity of each of said medical practitioner through analyzing a voice recording of each of said medical practitioner.

36. The method according to claim 29, further comprising:
verifying an identity of each of said medical practitioners through biometric analysis of each of said medical practitioners' voice.

37. The method according to claim 30, further comprising:
accessing said central database to review at least one of said plurality of clinical data entries; and
modifying said at least one of said plurality of clinical data entry by providing a revised clinical data entry in a form of an additional voice input, recording said revised clinical data entry on in said database, and associating a digital recording of said additional voice input with said revised clinical data entry.

38. A computer system for clinical data entry and authentication comprising:
a computer configured to receive electronic voice communications from a plurality of remotely locations, said computer is further configured to prompt a user to provide a clinical data of a patient through a voice input via one of said electronic voice communications, save said voice input digitally on said computer, then convert said digitally saved voice input to a data entry in a database, and associate said data entry with said digitally saved voice input.

39. The computer system according to claim 38, wherein said data entry comprises a textual representation.

40. The computer system according to claim 38, further comprising:
a first electronic interface which connects said computer to a public telephone network.

41. The computer system according to claim 40, further comprising:
a second electronic interface which connects said computer to an Internet.

42. The computer system according to claim 38, wherein said computer is further configured with a voice authentication capability to verify an identity of said user.

43. The computer system according to claim 42, wherein said computer is further configured with a voice edit check functionality to reject said clinical data when said clinical data is outside of a predefined parameter.

44. The computer system according to claim 43, wherein said computer comprises a voice recognition server having voice authentication capability, an instruction set server which provides an executable script to said voice recognition server, and a data server which receives said clinical data from said voice recognition server and stores said clinical data.

45. The computer system according to claim 38, wherein said computer is further configured to provide an identity stamp and a time stamp to said data entry in the database.

46. The computer system according to claim 43, wherein said computer is further configured to provide an identity stamp and a time stamp to said data entry in the database.

47. The computer system according to claim 39, wherein said computer is further configured to provide an identity stamp and a time stamp to said textual representation.

48. A method for capturing data for a database through voice entry comprising:
recording a voice entry, which is provided by a user, into a digital sound file;
converting the voice entry into a database entry through voice recognition; and
associating the digital sound file to the database entry.

49. The method according to claim 48, wherein the voice entry is provided through a remotely located telephone.

50. The method according to claim 48, further comprises determining the identity of the user through voice authentication of a sound input provide by the user.

51. The method according to claim 50, further comprises generating an identity tag based on the identity determined through voice recognition, and associating the identity tag with the database entry.
